(19) United States
(12) Patent Application Publication
(10) Pub. No.: US 2019/0042932 A1
(43) Pub. Date: Feb. 7, 2019

(54) Techniques and Architectures for Deep Learning to Support Security Threat Detection

(71) Applicant: salesforce com, inc., San Francisco, CA (US)

(72) Inventors: Lakshmisha BHAT, New York, NY (US); Ping Yan, San Francisco, CA (US); Sunny Patneedi, San Francisco, CA (US); Wei Deng, Sunnyvale, CA (US)

(21) Appl. No.: 15/665,926

(22) Filed: Aug. 1, 2017

(51) Int. Cl. G06N 3/08; H04L 29/06; G06F 17/30; G06N 5/04; G06N 3/04; G06F 17/18

(52) U.S. Cl. CPC G06N 3/08; H04L 63/1416; G06F 17/18; G06N 5/047; G06N 3/0445; G06F 17/30864

(57) ABSTRACT

Techniques and mechanisms for deep learning. A number of available tokens is reduced from a first-dimension space to tokens in a lower dimension space with a word embedding layer that receives a sequence of actions that correspond to an entity interacting with a secure computing environment. Patterns are extracted from the sequences of actions in the lower dimension space in at least a first direction with a first analysis layer and in at least a second direction with a second analysis layer. The extracted patterns are searched at a higher level of abstraction for higher level features and patterns from a larger feature space than the first analysis layer and the second analysis layer to generate a probability vector. Results from the probability vector are ranked with respect to tenants of a multitenant environment within the secure computing environment.

### TECHNICAL FIELD

Embodiments relate to electronic data security. More particularly, embodiments relate to techniques for monitoring accesses to electronic data/resources to identify patterns that indicate an attack.

### BACKGROUND

Data/resource security is a wide-ranging problem for nearly all users of electronic devices. Many strategies have been developed for detection of attacks. However, these strategies are generally reactive in that detection and/or correction only occurs after attacks have occurred. Thus, using traditional techniques, data/resources are exposed to novel attack vectors.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a high-level conceptual model of one embodiment of an architecture capable of identifying behaviors that indicate unauthorized access.

FIG. 2 is a block diagram of one embodiment of a stacked long short-term memory (LSTM) network that can be utilized to provide the functionality described herein.

FIG. 3 illustrates a block diagram of an environment where an on-demand database service might be used.

FIG. 4 illustrates a block diagram of an environment where an on-demand database service might be used.

### DETAILED DESCRIPTION

In the following description, numerous specific details are set forth. However, embodiments of the invention may be practiced without these specific details. In other instances, well-known structures and techniques have not been shown in detail in order not to obscure the understanding of this description.

Techniques described herein are applicable within a multitenant environment. As used herein, a tenant includes a group of users who share a common access with specific privileges to a software instance. A multi-tenant architecture provides a tenant with a dedicated share of the software instance typically including one or more of tenant specific data, user management, tenant-specific functionality, configuration, customizations, non-functional properties, associated applications, etc. Multi-tenancy contrasts with multi-instance architectures, where separate software instances operate on behalf of different tenants.

Various embodiments can provide a tenant-level (or organization-level) sequence recognition capability. In one embodiment, sequences of events from a first session (or group of sessions) can be utilized to train a model to recognize a tenant (or org) to which a sequence belongs. This model can be utilized, for example, to detect a sequence anomaly corresponding to an access (or attempted access) to one or more tenants/orgs.

In one embodiment, given a sequence of events from a first tenant are analyzed and ordered according to likelihood of being associated with multiple other tenants. In one embodiment, if the sequence of events from the first tenant are within a high enough ranking (e.g., top 10%, top 30%, top 250, top 30), then the sequence of events can be considered acceptable.

One of the advantages of the techniques and architectures described herein is that no previous statistical analysis is needed to generate the feature vectors to be used. That is, the embodiments described need only the actual input from users/groups/organizations. In various embodiments, organization/tenant level analysis is performed in a multitenant environment so that the analysis is not dependent on specific users and/or specific behaviors.

Malware-based attacks, for example, leveraging Dyre and VawTrak, can be difficult to detect and stop using previous security technologies. The techniques and architectures described herein can be more effective in detecting and responding to these types of attacks. Dyre is a Trojan-based man-in-the-browser attack. There have been waves of attacks from Dyre attackers involving cloud customers/users where data exfiltration was attempted or successful. VawTrak, for example, is available via a much more sophisticated crimeware-as-a-service network.

Unlike Dyre, VawTrak actors generally access a computing environment via tunneling through compromised endpoints. Some mitigation of the VawTrak-based attacks is now in place, but they rely on highly-specific endpoint characteristics that are only found after accounts were originally compromised.

Moreover, Man-in-the-Browser (MitB) attacks, where a previously installed Trojan horse is used to act between the browser and the browser's security mechanism, sniffing or modifying transactions as they are formed on the browser, but still displaying back the user's intended transaction, and other forms of session takeover have been advancing in sophistication and have little to no endpoint footprint. MitB attacks are common against financial institutions, for example. As described herein, a differentiation that allows a service provider to tell a benign user from an attacker can be based on the sequences of end user interaction with the environment through, for example, activity sequences.

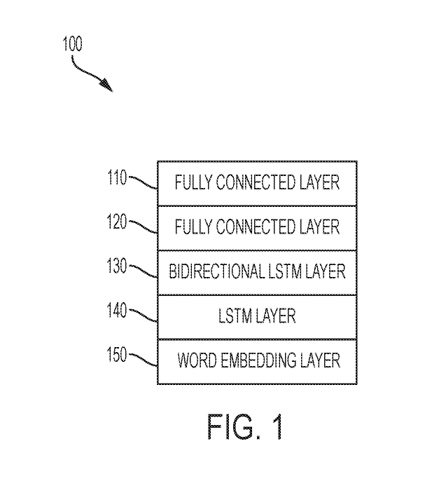

FIG. 1 is a high-level conceptual model of one embodiment of an architecture capable of identifying behaviors that indicate unauthorized access. In various embodiments described herein logged events are analyzed to determine if different activity is from the same user, and can trigger an alert or other response if suspicious activity is detected.

In one embodiment, the techniques and mechanisms described herein provide a generic model that can be used for analyzing sequences of activities at a tenant (or organization) level within a multitenant environment. A model can be built and the used to analyze a sequence of activity to determine a probability that the activity belongs to various organizations with in the environment. If the probability is too low, the activity can be flagged for further analysis and/or a response. A low probability can indicate, for example, a stolen credential because the activity of the user is different than expected for that credential.

The example model of FIG. 1 includes word embedding layer 150, long short-term memory (LSTM) layer 140, bidirectional LSTM layer 130, fully connected layer 120 and fully connected layer 110. In one embodiment, word embedding layer 150 functions to reduce the number of available tokens (e.g., ˜82,000 for a large set input vocabulary) to a smaller number of nodes (e.g., 128). In one embodiment, each user action (e.g., click) is considered a “token” or log entry. For example, a universal resource locator (URL) can be treated as a single token. In one embodiment, word embedding layer projects the space with one dimension per token to a continuous vector space with a much lower dimension.

In one embodiment, LSTM layer 140 functions to extract patterns and/or features from sequences of data in the lower dimension space to which word embedding layer 150 projected the original tokens. In one embodiment, LSTM layer 140 scans the tokens in the forward direction to attempt to determine what the next action will be.

In one embodiment, LSTM layer 140 includes multiple (e.g., 128, 256, 1024) long short-term memory units. The LSTM units provide a recurrent neural network (RNN) functionality that can be used for pattern/feature extraction as described herein. In general, a LSTM network is well-suited to classify, process and predict sequences that involve time lags between important events.

LSTM networks can learn long-term dependencies and have the form of a chain of repeating modules of a neural network. Thus, LSTM layers within the model illustrated in FIG. 1 can be utilized to learn the expected behaviors of one or more users (or organizations) and to subsequently analyze actions to determine if the subsequent actions are consistent with the patterns and behaviors of the users/organizations.

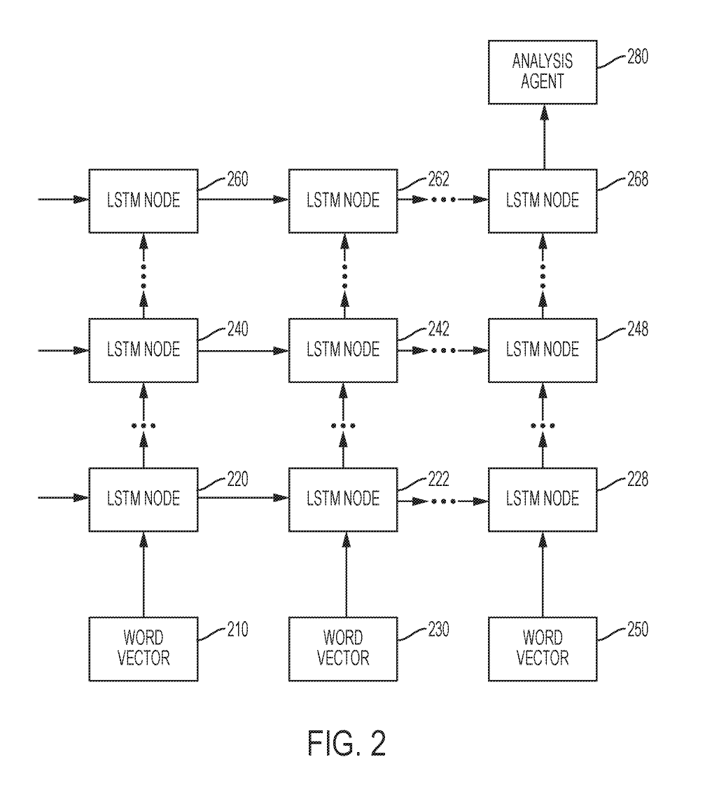

In one embodiment, bidirectional LSTM (BLSTM) layer 130 functions to scan both directions (i.e., forward and backward) to look for patterns. In one embodiment, bidirectional LSTM layer 130 operates on the output of LSTM layer 140. In one embodiment, bidirectional LSTM layer 130 can be a mesh of LSTM nodes (e.g., 128×128, 256×256, 128×256). FIG. 2 and the corresponding description provides further details on various embodiments of LSTM layer 140 and BLSTM layer 130.

In general, output of a bidirectional layer at step t not only depends on the past steps (e.g., t−1, . . . t1), but also depends on future steps (e.g., t+1, . . . T). In one embodiment, the forward pass abstracts and summarizes the context in the forward direction while the backward pass does the same from the reverse direction.

In one embodiment, fully connected layer 120 functions as a higher abstraction layer than LSTM layer 140 or BLSTM layer 130 to look for patterns in activity. In one embodiment, fully connected layer 120 operates on the output of BLSTM layer 130 to detect higher level features and patterns from a larger feature space (e.g., 256, 1024) and generates an output vector with probabilities that the input activity represents each of a smaller class of actions (e.g., 128, 256).

In one embodiment, fully connected layer 110 similarly provides a higher level of abstract analysis on the output vector from fully connected layer 120. In one embodiment, fully connected layer 110 operates to generate a probability vector indicating the probability for an input activity/sequence to correspond to each of a group of organizations/tenants in a multitenant environment.

FIG. 2 is a block diagram of one embodiment of a stacked long short-term memory (LSTM) network that can be utilized to provide the functionality described herein. The example architecture of FIG. 2 can be utilized to provide the functionality of BLSTM layer 130 and fully connected layer 120 of FIG. 1.

In general, LSTM neural networks are a special kind of Recurrent Neural Networks (RNNs), capable of learning long-term dependencies. The same as all RNNs, LSTM networks have the form of a chain of repeating modules of neural network. They operate on sequences or lists of tokens, or words and are capable of learning both short-term and long-term dependencies over the input due to its natural chain-like architecture and the special design of its network structure within each unit that comprises at least an input gate, forget gate and output gate that regulate how information flows through.

FIG. 2 illustrates one embodiment of a multiple-layer LSTM network. In one embodiment, a stacked deep learner supports hierarchical computations, where each hidden layer corresponds to a degree of abstraction. This design is useful with deep neural networks and facilitates implementations with parallel hardware.

In general, a network of LSTM nodes (e.g., 220, 222, 228, 240, 242, 248, 260, 262, 268) operate on one or more word vectors (e.g., 210, 230, 250) to search the word vectors for patterns. In one embodiment, the results of the LSTM node analysis are provided to analysis agent 280.

FIG. 2 illustrates one embodiment of a stacked LSTM neural network with recurrent/repeating LSTM units such that LSTM nodes 220, 222, . . . 228 operate to provide a first layer, LSTM nodes 240, 242, . . . 248 provide a second layer and LSTM nodes 260, 262, . . . 268 provide a final layer. Any number of LSTM nodes can be included in a layer and any number of layers can be supported.

In one embodiment, analysis agent 280 is an analysis agent that applies a softmax function to the results received from the LSTM nodes. In one embodiment, the output of analysis agent 280 is a probability distribution over the tenants of the multitenant environment. This probability distribution can be used to indicate the probability that input actions (e.g., from the word vectors) correspond to each of the tenants of the environment.

In one embodiment, analysis agent 280 is a multi-class classifier that uses a cross-entropy loss function to generate the probability distribution; however, other functions can also be utilized. In one embodiment, during training (or the learning phase), the gradient of the cross-entropy loss function is used by a (e.g., SoftMax) classifier to update weighting factors using, for example, a gradient descent (or similar) optimization technique.

In one embodiment, if the source tenant of the actions being analyzed ranks highly enough in the probability distribution (e.g., top 25% of tenants, top 20 tenants, top 50% of tenants, top 35 tenants), the actions can be considered safe. If not, the actions can be considered suspicious. In various embodiments, suspicious actions are flagged for further security analysis/action.

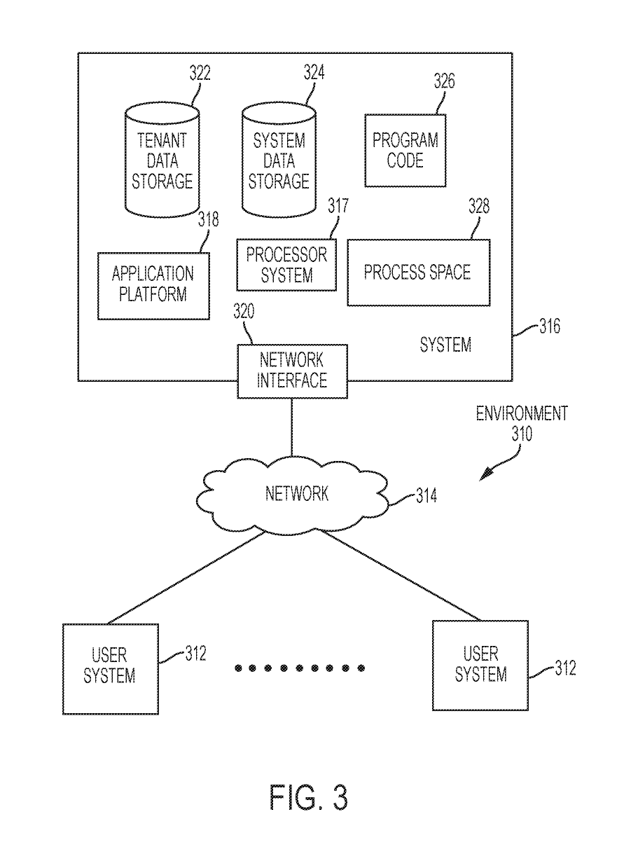

FIG. 3 illustrates a block diagram of an environment 310 wherein an on-demand database service might be used. Environment 310 may include user systems 312, network 314, system 316, processor system 317, application platform 318, network interface 320, tenant data storage 322, system data storage 324, program code 326, and process space 328. In other embodiments, environment 310 may not have all of the components listed and/or may have other elements instead of, or in addition to, those listed above.

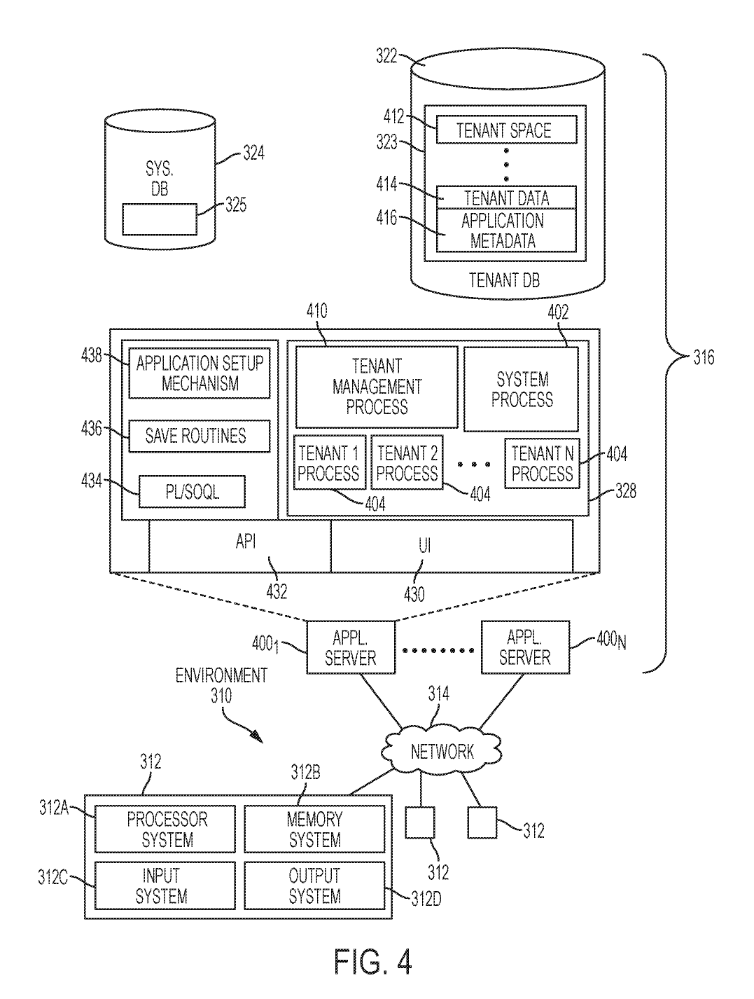

Environment 310 is an environment in which an on-demand database service exists. User system 312 may be any machine or system that is used by a user to access a database user system. For example, any of user systems 312 can be a handheld computing device, a mobile phone, a laptop computer, a work station, and/or a network of computing devices. As illustrated in herein FIG. 3 (and in more detail in FIG. 4) user systems 312 might interact via a network 314 with an on-demand database service, which is system 316.

An on-demand database service, such as system 316, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 316” and “system 316” will be used interchangeably herein. A database image may include one or more database objects. A relational database management system (RDMS) or the equivalent may execute storage and retrieval of information against the database obj ect(s). Application platform 318 may be a framework that allows the applications of system 316 to run, such as the hardware and/or software, e.g., the operating system. In an embodiment, on-demand database service 316 may include an application platform 318 that enables creation, managing and executing one or more applications developed by the provider of the on-demand database service, users accessing the on-demand database service via user systems 312, or third party application developers accessing the on-demand database service via user systems 312.

The users of user systems 312 may differ in their respective capacities, and the capacity of a particular user system 312 might be entirely determined by permissions (permission levels) for the current user. For example, where a salesperson is using a particular user system 312 to interact with system 316, that user system has the capacities allotted to that salesperson. However, while an administrator is using that user system to interact with system 316, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 314 is any network or combination of networks of devices that communicate with one another. For example, network 314 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 312 might communicate with system 316 using TCP/IP and, at a higher network level, use other common Internet protocols to communicate, such as HTTP, FTP, AFS, WAP, etc. In an example where HTTP is used, user system 312 might include an HTTP client commonly referred to as a “browser” for sending and receiving HTTP messages to and from an HTTP server at system 316. Such an HTTP server might be implemented as the sole network interface between system 316 and network 314, but other techniques might be used as well or instead. In some implementations, the interface between system 316 and network 314 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 316, shown in FIG. 3, implements a web-based customer relationship management (CRM) system. For example, in one embodiment, system 316 includes application servers configured to implement and execute CRM software applications as well as provide related data, code, forms, webpages and other information to and from user systems 312 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 316 implements applications other than, or in addition to, a CRM application. For example, system 316 may provide tenant access to multiple hosted (standard and custom) applications, including a CRM application. User (or third party developer) applications, which may or may not include CRM, may be supported by the application platform 318, which manages creation, storage of the applications into one or more database objects and executing of the applications in a virtual machine in the process space of the system 316.

One arrangement for elements of system 316 is shown in FIG. 3, including a network interface 320, application platform 318, tenant data storage 322 for tenant data 323, system data storage 324 for system data 325 accessible to system 316 and possibly multiple tenants, program code 326 for implementing various functions of system 316, and a process space 328 for executing MTS system processes and tenant-specific processes, such as running applications as part of an application hosting service. Additional processes that may execute on system 316 include database indexing processes.

Several elements in the system shown in FIG. 3 include conventional, well-known elements that are explained only briefly here. For example, each user system 312 could include a desktop personal computer, workstation, laptop, PDA, cell phone, or any wireless access protocol (WAP) enabled device or any other computing device capable of interfacing directly or indirectly to the Internet or other network connection. User system 312 typically runs an HTTP client, e.g., a browsing program, such as Edge from Microsoft, Safari from Apple, Chrome from Google, or a WAP-enabled browser in the case of a cell phone, PDA or other wireless device, or the like, allowing a user (e.g., subscriber of the multi-tenant database system) of user system 312 to access, process and view information, pages and applications available to it from system 316 over network 314. Each user system 312 also typically includes one or more user interface devices, such as a keyboard, a mouse, touch pad, touch screen, pen or the like, for interacting with a graphical user interface (GUI) provided by the browser on a display (e.g., a monitor screen, LCD display, etc.) in conjunction with pages, forms, applications and other information provided by system 316 or other systems or servers. For example, the user interface device can be used to access data and applications hosted by system 316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 312 and all of its components are operator configurable using applications, such as a browser, including computer code run using a central processing unit such as an Intel Core series processor or the like. Similarly, system 316 (and additional instances of an MTS, where more than one is present) and all of their components might be operator configurable using application(s) including computer code to run using a central processing unit such as processor system 317, which may include an Intel Core series processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 316 is configured to provide webpages, forms, applications, data and media content to user (client) systems 312 to support the access by user systems 312 as tenants of system 316. As such, system 316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 4 also illustrates environment 310. However, in FIG. 4 elements of system 316 and various interconnections in an embodiment are further illustrated. FIG. 4 shows that user system 312 may include processor system 312A, memory system 312B, input system 312C, and output system 312D. FIG. 4 shows network 314 and system 316. FIG. 4 also shows that system 316 may include tenant data storage 322, tenant data 323, system data storage 324, system data 325, User Interface (UI) 430, Application Program Interface (API) 432, PL/SOQL 434, save routines 436, application setup mechanism 438, applications servers 400₁-400_{N}, system process space 402, tenant process spaces 404, tenant management process space 410, tenant storage area 412, user storage 414, and application metadata 416. In other embodiments, environment 310 may not have the same elements as those listed above and/or may have other elements instead of, or in addition to, those listed above.

User system 312, network 314, system 316, tenant data storage 322, and system data storage 324 were discussed above in FIG. 3. Regarding user system 312, processor system 312A may be any combination of one or more processors. Memory system 312B may be any combination of one or more memory devices, short term, and/or long term memory. Input system 312C may be any combination of input devices, such as one or more keyboards, mice, trackballs, scanners, cameras, and/or interfaces to networks. Output system 312D may be any combination of output devices, such as one or more monitors, printers, and/or interfaces to networks. As shown by FIG. 4, system 316 may include a network interface 320 (of FIG. 3) implemented as a set of HTTP application servers 400, an application platform 318, tenant data storage 322, and system data storage 324. Also shown is system process space 402, including individual tenant process spaces 404 and a tenant management process space 410. Each application server 400 may be configured to tenant data storage 322 and the tenant data 323 therein, and system data storage 324 and the system data 325 therein to serve requests of user systems 312. The tenant data 323 might be divided into individual tenant storage areas 412, which can be either a physical arrangement and/or a logical arrangement of data. Within each tenant storage area 412, user storage 414 and application metadata 416 might be similarly allocated for each user. For example, a copy of a user's most recently used (MRU) items might be stored to user storage 414. Similarly, a copy of MRU items for an entire organization that is a tenant might be stored to tenant storage area 412. A UI 430 provides a user interface and an API 432 provides an application programmer interface to system 316 resident processes to users and/or developers at user systems 312. The tenant data and the system data may be stored in various databases, such as one or more Oracle™ databases.

Application platform 318 includes an application setup mechanism 438 that supports application developers' creation and management of applications, which may be saved as metadata into tenant data storage 322 by save routines 436 for execution by subscribers as one or more tenant process spaces 404 managed by tenant management process 410 for example. Invocations to such applications may be coded using PL/SOQL 434 that provides a programming language style interface extension to API 432. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 416 for the subscriber making the invocation and executing the metadata as an application in a virtual machine.

Each application server 400 may be communicably coupled to database systems, e.g., having access to system data 325 and tenant data 323, via a different network connection. For example, one application server 400₁ might be coupled via the network 314 (e.g., the Internet), another application server 400_{N-1} might be coupled via a direct network link, and another application server 400_{N} might be coupled by yet a different network connection. Transfer Control Protocol and Internet Protocol (TCP/IP) are typical protocols for communicating between application servers 400 and the database system. However, it will be apparent to one skilled in the art that other transport protocols may be used to optimize the system depending on the network interconnect used.

In certain embodiments, each application server 400 is configured to handle requests for any user associated with any organization that is a tenant. Because it is desirable to be able to add and remove application servers from the server pool at any time for any reason, there is preferably no server affinity for a user and/or organization to a specific application server 400. In one embodiment, therefore, an interface system implementing a load balancing function (e.g., an F5 BIG-IP load balancer) is communicably coupled between the application servers 400 and the user systems 312 to distribute requests to the application servers 400. In one embodiment, the load balancer uses a least connections algorithm to route user requests to the application servers 400. Other examples of load balancing algorithms, such as round robin and observed response time, also can be used. For example, in certain embodiments, three consecutive requests from the same user could hit three different application servers 400, and three requests from different users could hit the same application server 400. In this manner, system 316 is multi-tenant, wherein system 316 handles storage of, and access to, different objects, data and applications across disparate users and organizations.

As an example of storage, one tenant might be a company that employs a sales force where each salesperson uses system 316 to manage their sales process. Thus, a user might maintain contact data, leads data, customer follow-up data, performance data, goals and progress data, etc., all applicable to that user's personal sales process (e.g., in tenant data storage 322). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 316 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 316 might also maintain system level data usable by multiple tenants or other data. Such system level data might include industry reports, news, postings, and the like that are sharable among tenants.

In certain embodiments, user systems 312 (which may be client systems) communicate with application servers 400 to request and update system-level and tenant-level data from system 316 that may require sending one or more queries to tenant data storage 322 and/or system data storage 324. System 316 (e.g., an application server 400 in system 316) automatically generates one or more SQL statements (e.g., one or more SQL queries) that are designed to access the desired information. System data storage 324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A non-transitory computer-readable medium having stored thereon instructions that, when executed by one or more processors, are configurable to cause the one or more processors to:
reduce a number of available tokens from a first-dimension space to tokens in a lower dimension space with a word embedding layer that receives a sequence of actions that correspond to an entity interacting with a secure computing environment;
extract patterns from the sequences of actions in the lower dimension space in at least a first direction with a first analysis layer and in at least a second direction with a second analysis layer;
search the extracted patterns at a higher level of abstraction for higher level features and patterns from a larger feature space than the first analysis layer and the second analysis layer to generate a probability vector; and
rank results from the probability vector with respect to tenants of a multitenant environment within the secure computing environment.

2. The non-transitory computer-readable medium of claim 1 wherein the entity comprises one or more users corresponding to a tenant of a multitenant environment, and wherein the secure computing environment comprises the multitenant environment.

3. The non-transitory computer-readable medium of claim 1 wherein the instructions that, when executed by the one or more processors, cause the one or more processors to extract patterns from the sequences of actions in the lower dimension space in at least a first direction with a first layer and in at least a second direction with a second layer, further comprise instructions that, when executed by the one or more processors, cause the one or more processors to:
extract patterns from the sequences of actions in the lower dimension space by scanning the tokens in a forward direction with a first analysis layer to generate a set of scanned patterns; and
scan the scanned pattern in a forward direction and a reverse direction with a second analysis layer to extract a set of bi-directional patterns from the set of scanned patterns.

4. The non-transitory computer-readable medium of claim 3 wherein the extracting patterns from the sequences of actions in the lower dimension space by scanning the tokens in a forward direction with the first analysis layer is performed by a long short-term memory (LSTM) layer comprising a first set of LSTM nodes.

5. The non-transitory computer-readable medium of claim 3 wherein the scan the scanned pattern in a forward direction and a reverse direction with the second analysis layer to extract a set of bi-directional patterns from the set of scanned patterns is performed by a bidirectional LSTM (BLSTM) layer comprising a second set of LSTM nodes.

6. The non-transitory computer-readable medium of claim 5 wherein the second set of LSTM nodes comprises a mesh of LSTM nodes.

7. The non-transitory computer-readable medium of claim 1 wherein the instructions that, when executed by the one or more processors, cause the one or more processors to search the extracted patterns at a higher level of abstraction for higher level features and patterns from a larger feature space than the first analysis layer and the second analysis layer to generate a probability vector, further comprise instructions that, when executed by the one or more processors, cause the one or more processors to:
search a set of bi-directional patterns at a first higher level of abstraction than the first analysis layer and the second analysis layer to search for higher level features and patterns from a larger feature space than the first analysis layer and the second analysis layer to generate an output vector; and
search the output vector at a second higher level of abstraction to generate a probability vector.

8. The non-transitory computer-readable medium of claim 7 wherein the searching the set of bi-directional patterns at a higher level of abstraction than the first analysis layer and the second analysis layer to search for higher level features and patterns from a larger feature space than the first analysis layer and the second analysis layer is performed by a first fully connected layer.

9. The non-transitory computer-readable medium of claim 7 wherein searching the output vector at a second higher level of abstraction to generate a probability vector is performed by a second fully connected layer.

10. A computer-implemented method comprising:
reducing, with one or more hardware processing devices, a number of available tokens from a first-dimension space to tokens in a lower dimension space with a word embedding layer that receives a sequence of actions that correspond to an entity interacting with a secure computing environment;
extracting, with the one or more hardware processing devices, patterns from the sequences of actions in the lower dimension space in at least a first direction with a first analysis layer and in at least a second direction with a second analysis layer;
searching, with the one or more hardware processing devices, the extracted patterns at a higher level of abstraction for higher level features and patterns from a larger feature space than the first analysis layer and the second analysis layer to generate a probability vector; and
ranking, with the one or more hardware processing devices, results from the probability vector with respect to tenants of a multitenant environment within the secure computing environment.

11. The method of claim 10 wherein the entity comprises one or more users corresponding to a tenant of a multitenant environment, and wherein the secure computing environment comprises the multitenant environment.

12. The method of claim 10 wherein the extracting patterns from the sequences of actions in the lower dimension space in at least a first direction with a first layer and in at least a second direction with a second layer, further comprises:
extracting, with the one or more hardware processing devices, patterns from the sequences of actions in the lower dimension space by scanning the tokens in a forward direction with a first analysis layer to generate a set of scanned patterns; and
scanning, with the one or more hardware processing devices, the scanned pattern in a forward direction and a reverse direction with a second analysis layer to extract a set of bi-directional patterns from the set of scanned patterns.

13. The method of claim 12 wherein the extracting patterns from the sequences of actions in the lower dimension space by scanning the tokens in a forward direction with the first analysis layer is performed by a long short-term memory (LSTM) layer comprising a first set of LSTM nodes.

14. The method of claim 12 wherein the scanning the scanned pattern in a forward direction and a reverse direction with the second analysis layer to extract a set of bi-directional patterns from the set of scanned patterns is performed by a bidirectional LSTM (BLSTM) layer comprising a second set of LSTM nodes.

15. The method of claim 14 wherein the second set of LSTM nodes comprises a mesh of LSTM nodes.

16. The method of claim 10 wherein searching the extracted patterns at a higher level of abstraction for higher level features and patterns from a larger feature space than the first analysis layer and the second analysis layer to generate a probability vector, further comprises:
searching, with the one or more hardware processing devices, a set of bi-directional patterns at a first higher level of abstraction than the first analysis layer and the second analysis layer to search for higher level features and patterns from a larger feature space than the first analysis layer and the second analysis layer to generate an output vector; and
searching, with the one or more hardware processing devices, the output vector at a second higher level of abstraction to generate a probability vector.

17. The method of claim 16 wherein the searching the set of bi-directional patterns at a higher level of abstraction than the first analysis layer and the second analysis layer to search for higher level features and patterns from a larger feature space than the first analysis layer and the second analysis layer is performed by a first fully connected layer.

18. The method of claim 16 wherein searching the output vector at a second higher level of abstraction to generate a probability vector is performed by a second fully connected layer.
